(19) United States
(12) Patent Application Publication
(10) Pub. No.: US 2012/0314779 A1
(43) Pub. Date: Dec. 13, 2012

(54) SUPERIMPOSED NETWORK CODING METHOD

(75) Inventors: Wei-Cheng LIU, Taichung City (TW); Mao-Ching CHIU, Chiayi County (TW)

(73) Assignee: NATIONAL CHUNG CHENG UNIVERSITY, Chia-Yi (TW)

(21) Appl. No.: 13/344,017

(22) Filed: Jan. 5, 2012

(30) Foreign Application Priority Data
Jun. 10, 2011 (TW) 100120344

(51) Int. Cl. H04B 14/04

(52) U.S. Cl. 375/242

(57) ABSTRACT

A superimposed network coding method, that is applicable to communication in a network, containing a first, a second, and a third network nodes, comprising following steps: firstly, the first network node transmits its first data to the second, and the third network nodes, so that the second and the third network nodes receive corresponding signals; next, the second network node transmits its second data to the first and the third network nodes, so that the first and the third network nodes receive the corresponding signal; then, the third network node superimposes and sums signals received with summation weights to generate a superimposed signal, and transmits it to the first and the second network nodes; finally, the first and the second network nodes delete their own data from signals received, and then demodulate the signals received to obtain the second data and the first data.

### BACKGROUND OF THE INVENTION

1. Field of the Invention

The present invention relates to a coding method, and in particular to a superimposed network coding method.

2. The Prior Arts

Nowadays, signal duplication is used quite often in communications, however, too large volume of information is liable to cause network congestion. In this respect, the network in FIG. 1 is taken as an example for explanation. Supposing that each arrow contained therein indicates transmitting a signal, with its value of 0 or 1. In this design, point A 10 sends both signals x and y to point B 12 and point C 14. However, the problem is that, when point M 16 receives signals x and y, it can only transmit a signal, thus if it transmits x, then point B 12 will not receive y, and if it transmits y, then point C 14 will not receive x. In this kind of situation, “network coding” provides a good solution, through allowing point M 16 to send out a signal x⊕y indicating difference and similarity of signals x and y, such that when point B 12 receives x and x⊕y, it can solve and obtain y; likewise, when point C 14 receives y and x⊕y, it can solve and obtain x.

In addition, a network transmission technology is provided, which utilizes double direction data exchange mode, and it requires 4 steps to complete the process flow. As shown in FIG. 2, when point a 18 and point b 20 intend to exchange data with each other through point r 22; firstly, point a 18 sends signal Xa of its own to point b 20 and point r 22; next, point b 20 sends signal Xb of its own to point a 18 and point r 22; then, point r 22 sends out signal Xb simultaneously to point a 18 and point b 20; and finally point r 22 sends out signal Xa simultaneously to point a 18 and point b 20, thus completing the data exchange process flow. In this method, quite a few steps are involved, so that the data transmission rate is slow. Moreover, U.S. Pat. No. 7,414,978 discloses “Minimum-Cost Routing with Network Coding” and the computer program product; and U.S. Pat. No. 7,660,301 discloses “System and Method For Network Coding and Multicast”; and Thesis of Li-Chun Wang, Wei-Cheng Liu, and Sau-Hsuan Wu discloses “Diversity-multiplexing tradeoff analysis of a cooperative network coding system”, IEEE Sarnoff Symposium 2009, Princeton, N.J., USA, pp 1-5, Mar. 30-Apr. 1, 2009, wherein, the technologies of network coding and decode-and-forward (DF) are combined to improvement the Diversity-Multiplexing tradeoff of three-node type network. The network coding technologies of the three cases mentioned above are overly complicated, and they are not easy to be realized on hardware. In another thesis of R. H. Y. Louie, Y. Li, and B. Vucetic discloses “Practical physical layer network coding for two-way relay channels: performance analysis and comparison”, IEEE Trans. Wireless Commun., vol. 9, no. 2, pp. 764-777, February 2010, wherein analysis and comparison of effectiveness of several existing communication systems are provided, yet no new transmission methods are proposed.

Therefore, presently, the design and application of a coding method utilized in transmission is not quite satisfactory, and it has much room for improvement.

### SUMMARY OF THE INVENTION

In view of the problems and shortcomings of the prior art, the present invention provides a superimposed network coding method, so as to solve the problem of the prior art.

A major objective of the present invention is to provide a superimposed network coding method, wherein, the signals of the physical layer are summed up directly, and summation weighting is designed, so that it can not only raise the transmission speed, but it can also maximize the system summation rate for Gauss input, thus it can have the advantages of simple in operation, and can be realized easily on hardware.

In order to achieve the above-mentioned objective, the present invention provide a superimposed network coding method, that is applicable to communications in a network, comprising a first, a second, and a third network nodes, wherein, the first and second network nodes exchange data with each other through a third network node, comprising the following steps: firstly, the first network node transmits its first data to the second, and third network nodes, so that the second and third network nodes receive respectively the first and second signals containing the first data. Next, the second network node transmits its second data to the first and third network nodes, so that the first and third network nodes receive respectively the third and the fourth signals containing the second data. Then, the third network node superimposes and sums the second and the fourth signals with summation weights to generate a superimposed signal, and transmits it to the first and the second network nodes, so that the first and the second network nodes receive respectively the fifth and sixth signals containing the superimposed signal. Subsequently, the first network node deletes the first data from the fifth signal, and the second network node deletes the second data from the sixth signal. Finally, the first and second network nodes demodulate the fifth and sixth signals to obtain the second and first data respectively.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of single direction network data transmission of the prior art;

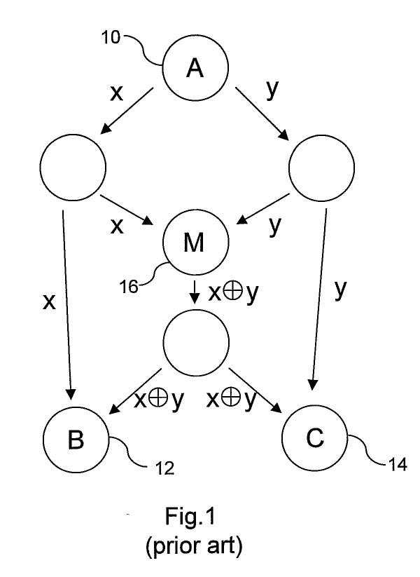

FIG. 2 is a is a schematic diagram of double direction network data transmission of the prior art;

FIG. 3 is a is a schematic diagram of network data transmission according to the present invention; and

FIG. 4 is a flowchart of the steps of superimposed network coding method according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

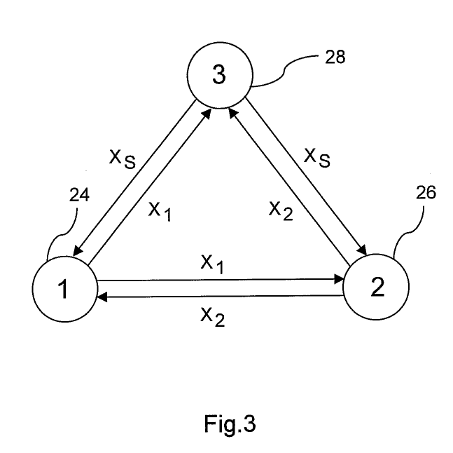

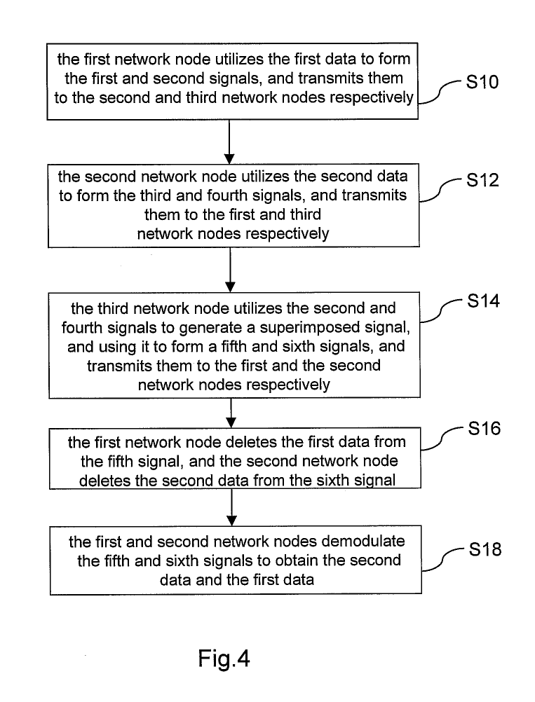

The superimposed network coding method of the present invention can be applicable to any wireless three-node network. Refer to FIGS. 3 and 4 for a schematic diagram of network data transmission according to the present invention, and a flowchart of the steps of superimposed network coding method according to the present invention. As shown in FIGS. 3 and 4, the first and second network nodes 24 and 26 must be provided with signal amplification and subtraction functions, and the third network node 28 must be provided with signal amplification and summation functions. In case that it is desired to obtain optimum value of summation weights when the input is Gaussian, then the third network node 28 must be able to calculate and obtain the variance of noise, and the three network nodes must also able to calculate and obtain channel gains.

In the following, a system of three-node network is described, wherein, the first and second network nodes 24 and 26 intend to exchange data with each other via a third network node 28, so that in the system design, the first, second, and third network nodes 24, 26, and 28 are all designed to have a positive transmission power upper limit P.

As shown in FIG. 4, firstly, as shown in step S10, the first network node 24 transmits its first data x₁ to the second and third network nodes 26 and 28, so that the second and third network nodes 26 and 28 receive respectively the first signal y_{1,2}=h_{1,2}x₁+n_{1,2} and second signals y_{1,3}=h_{1,3}x₁+n_{1,3}, both containing the first data x₁, wherein, the transmission power of the first signal is less than or equal to P, namely E[|x₁|²]≦P, and h_{1,2}, n_{1,2} are respectively the first channel gain and the first addable white Gaussian noise of signals transmitted from the first network node 24 to the second network node 26, and h_{1,3}, n_{1,3} are respectively the second channel gain and the second addable white Gaussian noise of signals transmitted from the first network node 24 to the third network node 28. Next, as shown in step S12, the second network node 26 transmits its second data x₂ to the first and third network nodes 24 and 28, so that the first and third network nodes 24 and 28 receive respectively the third signal y_{2,1}=h_{2,1}x₂+n_{2,1} and fourth signals y_{2,3}=h_{2,3}x₂+n_{2,3}, both containing the second data x₂, wherein, the transmission power of the second signal is less than or equal to P, namely E[|x₂|²]≦P, and h_{2,1}, n_{2,1} are respectively the third channel gain and the third addable white Gaussian noise of signals transmitted from the second network node 26 to the first network node 24, and h_{2,3}, n_{2,3} are respectively the fourth channel gain and the fourth addable white Gaussian noise of signals transmitted from the second network node 26 to the third network node 28. Then, as shown in step S14, the third network node 28 superimposes and sums the second and the fourth signals through using summation weighting, to generate a superimposed signal x_{S}=αy_{1,3}+βy_{2,3}, wherein, α and β represent the summation weights of the second and fourth signals respectively, and are both positive numbers. The third network node 28 then transmits the superimposed signal xₛ to the first and second network nodes 24 and 26, so that the first and second network nodes 24 and 26 receive respectively the fifth signal y_{3,1}=h_{3,1}xₛ+n_{3,1} and the sixth signal y_{3,2}=h_{3,2}xₛ+n_{3,2}, both containing the superimposed signal xₛ, wherein, the transmission power of the superimposed signal is less than or equal to P, namely E[|xₛ|²]≦P, and h_{3,1} and n_{3,1} are respectively the fifth channel gain and the fifth addable white Gaussian noise of signals transmitted from the third network node 28 to the first network node 24, and h_{3,2}, n_{3,2} are respectively the sixth channel gain and the sixth addable white Gaussian noise of signals transmitted from the third network node 28 to the second network node 26.

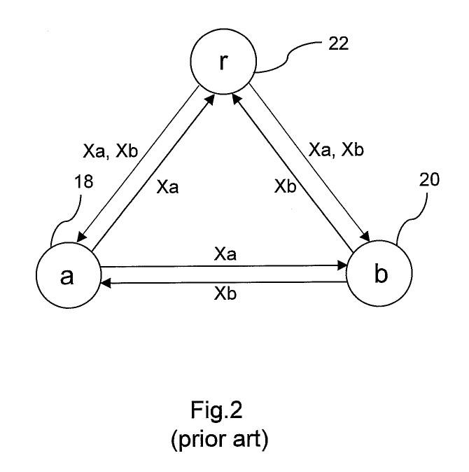

Up to now, the major signal coding and transmission process flow of the steps of superimposed network coding method according to the present invention is described, as compared with the signal coding technology of the prior art of FIG. 2, the present invention requires only three steps. Supposing that each step of the two methods requires the same amount of time to perform, then the present invention needs only 75% of the time required by the prior art for data transmission, namely the data transmission rate can be raised by 33%.

In addition, since the operation of the communication protocol of the present invention is quite simple, requiring only amplification and summation operations, thus it can be realized easily on hardware. Furthermore, in case it is desired to achieve maximum system summation rate for Gaussian input, namely the signals x1 and x2 transmitted are Gaussian random variables, then the following equations (1) and (2) must be satisfied:

$$\begin{matrix}α = \sqrt{\frac{BP}{P ( B {\vert {h}_{1 , 3} \vert}^{2} + A {\vert {h}_{2 , 3} \vert}^{2} ) + N ( A + B )}} & ( 1 ) \\ β = \sqrt{\frac{AP}{P ( B {\vert {h}_{1 , 3} \vert}^{2} + A {\vert {h}_{2 , 3} \vert}^{2} ) + N ( A + B )}} & ( 2 )\end{matrix}$$

wherein, A=\sqrt{2P|h_{1,3}|²+N}, B=\sqrt{2P|h_{2,3}|²+N}, N is a variance of noise. Since y_{3,1}=h_{3,1}xₛ+n_{3,1}=αh_{3,1}h_{1,3}x₁+βh_{3,1}h_{2,3}x₂+αh_{3,1} n_{1,3}+βh_{3,1}n_{2,3}+n_{3,1}, y_{3,2}=h_{3,2}xₛ+n_{3,2}=αh_{3,2}h_{1,3}x₁+βh_{3,2}h_{2,3}x₂+αh_{3,2}n_{1,3}+βh_{3,2}n_{2,3}+n_{3,2}, therefore, subsequently, as shown in step S16, the first network node 24 deletes the first data x1 from the fifth signal y3,1; and the second network node 26 deletes the second data x2 from the sixth signal y3,2. In other words, after rearrangement, the fifth signal after the deletion is, y′_{3,1}=βh_{3,1}h_{2,3}x₂+αh_{3,1}n_{1,3}+βh_{3,1}n_{2,3}+n_{3,1}, and the sixth signal after deletion is y′_{3,2}=αh_{3,2}h_{1,3}x₁+αh_{3,2}n_{1,3}+βh_{3,2}n_{2,3}+n_{3,2}. Finally, as shown in step S18, the first and second network nodes 24 and 26 demodulate the fifth and the sixth signals y3,1 and y3,2 to obtain the second and first data x₂ and x₁, hereby enabling the first network node 24 to receive two copies of x₂, and the second network node 26 may also receive two copies of x₁.

Summing up the above, in the present invention, the optimum summation weight design is utilized, to increase data transmission rate significantly, thus it can be realized easily on hardware.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A superimposed network coding method, applicable to communication in a network, containing a first, a second, and a third network nodes, said first and said second network nodes exchange data with each other through said third network node, comprising following steps:
said first network node transmits its first data to said second and said third network nodes, such that said second and third network nodes receive respectively a first and a second signals, both containing said first data;
said second network node transmit its second data to said first and said third network nodes, such that said first and said third network nodes receive respectively a third and a fourth signals, both containing said second data;
said third network node superimposes and sums said second and said fourth signals with summation weights to generate a superimposed signal, and transmits it to said first and said second network nodes, such that said first and said second network nodes receive respectively a fifth and a sixth signals, both containing said superimposed signal;
said first network node deletes said first data from said fifth signal, and said second network node deletes said second data from said sixth signal; and
said first and said second network nodes demodulate said fifth and said sixth signals to obtain said second and said first data respectively.

2. The superimposed network coding method as claimed in claim 1, wherein
said first, second, and third network nodes are all designed with a positive transmission power upper limit P, said transmission power of said first and said second signals are both less than or equal to P, such that said transmission power of said superimposed signal is less than or equal to P.

3. The superimposed network coding method as claimed in claim 1, wherein
said first data is x₁, said first signal y_{1,2}=h_{1,2}x₁+n_{1,2} and said second signal y_{1,3}=h_{1,3}x₁+n_{1,3}, and h_{1,2} and n_{1,2} are respectively a first channel gain and a first addable white Gaussian noise of signals transmitted from said first network node to said second network node, and h_{1,3} and n_{1,3} are respectively a second channel gain and a second addable white Gaussian noise of signals transmitted from said first network node to said third network node.

4. The superimposed network coding method as claimed in claim 1, wherein
said second data is x₂, said third signal y_{2,1}=h_{2,1}x₂+n_{2,1}, said fourth signals y_{2,3}=h_{2,3}x₂+n_{2,3}, h_{2,1} and n_{2,1} are respectively a third channel gain and a third addable white Gaussian noise of signals transmitted from said second network node to said first network node, and h_{2,3} and n_{2,3} are respectively a fourth channel gain and a fourth addable white Gaussian noise of signals transmitted from said second network node to said third network node.

5. The superimposed network coding method as claimed in claim 1, wherein
said superimposed signal xₛ=αy_{1,3}+βy_{2,3}, wherein, α and β represent said summation weights of said second and fourth signals respectively, and are both positive numbers, and y_{1,3} and y_{2,3} are said second and said fourth signals respectively.

6. The superimposed network coding method as claimed in claim 5, wherein
said fifth signal y_{3,1}=h_{3,1}xₛ+n_{3,1}, and said sixth signal y_{3,2}=h_{3,2}xₛ+n_{3,2}, h_{3,1} and n_{3,1} are respectively a fifth channel gain and a fifth addable white Gaussian noise of signals transmitted from said third network node to said first network node, and h_{3,2} and n_{3,2} are respectively a sixth channel gain and a sixth addable white Gaussian noise of signals transmitted from said third network node to said second network node.

7. The superimposed network coding method as claimed in claim 5, wherein
said first, second, and third network nodes are all designed with a positive transmission power upper limit P, such that
$$\begin{matrix}α = \sqrt{\frac{BP}{P ( B {\vert {h}_{1 , 3} \vert}^{2} + A {\vert {h}_{2 , 3} \vert}^{2} ) + N ( A + B )}} \\ β = \sqrt{\frac{AP}{P ( B {\vert {h}_{1 , 3} \vert}^{2} + A {\vert {h}_{2 , 3} \vert}^{2} ) + N ( A + B )}}\end{matrix}$$
wherein A=\sqrt{2P|h_{1,3}|²+N}, B=\sqrt{2P|h_{2,3}|²+N}, N is a variance of noise, h_{1,3} is said second channel gain of signals transmitted from said first network node to said third network node, and h_{2,3} is said fourth channel gain of signals transmitted from said second network node to said third network node.
